(19) United States
(12) Patent Application Publication
(10) Pub. No.: US 2026/0179506 A1
(43) Pub. Date: Jun. 25, 2026

(54) BLOOD VESSEL SIMULATOR

(71) Applicant: ASAHI INTECC CO., LTD., Seto-shi, Aichi (JP)

(72) Inventor: Hirobumi WATANABE, Irvine, CA (US)

(21) Appl. No.: 19/418,363

(22) Filed: Dec. 12, 2025

Related U.S. Application Data
(60) Provisional application No. 63/737,225, filed on Dec. 20, 2024.

(51) Int. Cl. G09B 23/30

(52) U.S. Cl. CPC G09B 23/30

(57) ABSTRACT

Embodiments of the present disclosure relate to simulation of blood vessels to visualize and quantify forces applied to the blood vessels during procedures using a system that allows visualization of endovascular procedures. An example blood vessel simulator of the present disclosure may include a vascular model system including: a base; an attachment point; a tube attached to the attachment point; a sensor, where the attachment point is attached to the sensor, the sensor is mounted to the base, and the sensor is configured to detect a force exerted on the tube from a guide wire traveling within the tube; a camera, wherein the camera is positioned to capture real time images of the base, the attachment point, and the tube; and a controller configured to generate a visual output of the real time images with an indication of the force exerted on the tube from the guide wire.

### CROSS-REFERENCE TO RELATED APPLICATIONS

This claims priority to U.S. Provisional App. No. 63/737,225, filed Dec. 20, 2024, the content of which is hereby incorporated by reference in its entirety.

### TECHNICAL FIELD

This application generally relates to simulation of blood vessels to visualize and quantify forces applied to the blood vessels during procedures.

### BACKGROUND

Endovascular procedures are minimally invasive procedures that employ catheters and other devices to diagnose, treat, and otherwise observe a patient's condition within blood vessels. Various conditions are treated through endovascular procedures and guide wires are often used to guide medical devices within the blood vessels of a patient. The process of inserting guide wires within a vessel is complex and challenging. Further, the process requires training and experience.

Endovascular procedures have been used to treat a wide variety of conditions. However, tortuous structures of the body may increase the difficulty of navigating a guide wire and/or endovascular device to a target site. The insertion of guide wires and endovascular devices within blood vessels is challenging and critically important during endovascular medical procedures. Improper insertion of guide wires and endovascular devices can result in significant injury to a patient. While obtaining experience in such endovascular procedures is necessary to educate a practitioner, providing such experience outside of a living patient is challenging.

### BRIEF SUMMARY

Embodiments of the present disclosure relate to simulation of blood vessels to visualize and quantify forces applied to the blood vessels during procedures using a system that allows visualization of endovascular procedures. An example blood vessel simulator of the present disclosure may include a vascular model system including: a base; at least one attachment point; a tube attached to the at least one attachment point; at least one sensor, where the at least one attachment point is attached to the at least one sensor, and where the at least one sensor is mounted to the base, where the at least one sensor configured to detect a force exerted on the tube from a guide wire traveling within the tube at the at least one attachment point; a camera, wherein the camera is positioned to capture real time images of the base, the at least one attachment point, and the tube; and a controller, where the controller is configured to generate a visual output of the real time images with an indication of the force exerted on the tube from the guide wire traveling within the tube at the at least one attachment point.

According to some embodiments the indication includes a force vector superimposed over an attachment point of the at least one attachment point, where the force vector provides the indication of the force exerted on the tube from the guide wire traveling within the tube at the at least one attachment point. According to certain embodiments the force vector provides the indication of a direction of the force exerted on the tube from the guide wire traveling within the tube at the at least one attachment point. The force vector of an example embodiment defines a size, wherein the size of the force vector reflects a magnitude of the force exerted on the tube from the guide wire traveling within the tube at the at least one attachment point.

According to some embodiments the force vector defines a color, where the color of the force vector reflects a magnitude of the force exerted on the tube from the guide wire traveling within the tube at the at least one attachment point. According to certain embodiments the color of the force vector is a first color in response to the magnitude of the force exerted on the tube from the guide wire traveling within the tube at the at least one attachment point being below a threshold, and wherein the color of the force vector is a second color in response to the magnitude of the force exerted on the tube from the guide wire traveling within the tube at the at least one attachment point being above the threshold.

The at least one attachment point of some embodiments is rotatable relative to the at least one sensor. The at least one attachment point of some embodiments is connected to the at least one sensor by a magnet. According to certain embodiments the at least one attachment point is repositionable within the base. The at least one attachment point and the tube attached to the at least one attachment point are in some embodiments positioned to simulate a blood vessel shape and size within a human vascular system. According to certain embodiments the at least one sensor comprises a pair of load cells, wherein the pair of load cells are configured to measure the force exerted on the tube from the guide wire traveling within the tube at the attachment point in two orthogonal axes.

Embodiments provided herein include a method for visualizing forces of a guide wire within a vascular model, the method including: positioning at least one attachment point on a base; attaching a tube to the at least one attachment point; connecting a sensor between the at least one attachment point and the base; measuring, with the sensor, a force exerted on the tube from a guide wire traveling within the tube; capturing real time images of the base, the at least one attachment point, and the tube; and generating a visual output of the real time images with an indication of the force exerted on the tube from the guide wire traveling within the tube.

The method of some embodiments includes providing the indication of the force exerted on the tube from the guide wire traveling within the tube at the at least one attachment point as a force vector. According to some embodiments the force vector provides the indication of a direction of the force exerted on the tube from the guide wire traveling within the tube at the at least one attachment point. According to certain embodiments the force vector defines a size, wherein the size of the force vector reflects a magnitude of the force exerted on the tube from the guide wire traveling within the tube at the at least one attachment point.

The force vector of an example embodiment defines a color, wherein the color of the force vector reflects a magnitude of the force exerted on the tube from the guide wire traveling within the tube at the at least one attachment point. According to some embodiments the color of the force vector is a first color in response to the magnitude of the force exerted on the tube from the guide wire traveling within the tube at the at least one attachment point being below a threshold, and wherein the color of the force vector is a second color in response to the magnitude of the force exerted on the tube from the guide wire traveling within the tube at the at least one attachment point being above the threshold.

The at least one attachment point of an example embodiment is rotatable relative to the sensor. According to some embodiments the at least one attachment point is connected to the sensor by a magnet. The method of some embodiments further includes repositioning the at least one attachment point within the base. The at least one attachment point and the tube attached to the at least one attachment point are, in an example embodiment, positioned on the base to simulate a blood vessel shape and size within a human vascular system. According to some embodiments the sensor includes a pair of load cells, wherein the pair of load cells configured to measure the force exerted on the tube from the guide wire traveling within the tube at the attachment point in two orthogonal axes.

Embodiments provided herein include a computer program product including at least one non-transitory computer-readable storage medium having computer-executable program code portions stored therein, the computer-executable program code portions including program code instructions configured to: measure, with at least one sensor, a force exerted on a tube from a guide wire traveling within the tube at one or more attachment points to a base; capture real time images of the base, the one or more attachment points, and the tube; and generate a visual output of the real time images with an indication of the force exerted on the tube from the guide wire traveling within the tube at the one or more attachment points.

The computer program product of some embodiments further includes program code instructions to provide the indication of the force exerted on the tube from the guide wire traveling within the tube at the one or more attachment points as a force vector. The force vector of an example embodiment provides the indication of a direction of the force exerted on the tube from the guide wire traveling within the tube at the one or more attachment points. The force vector of some embodiments defines a size, where the size of the force vector reflects a magnitude of the force exerted on the tube from the guide wire traveling within the tube at the one or more attachment points.

The force vector of an example embodiment defines a color, wherein the color of the force vector reflects a magnitude of the force exerted on the tube from the guide wire traveling within the tube at the one or more attachment points. According to some embodiments the color of the force vector is a first color in response to the magnitude of the force exerted on the tube from the guide wire traveling within the tube at the one or more attachment points being below a threshold, and wherein the color of the force vector is a second color in response to the magnitude of the force exerted on the tube from the guide wire traveling within the tube at the one or more attachment points being above the threshold.

### BRIEF DESCRIPTION OF THE FIGURES

Having thus described the embodiments of the disclosure in general terms, reference now will be made to the accompanying drawings, which are not necessarily drawn to scale, and wherein:

FIG. 1 illustrates an example of a system for visualization of the forces for objective dynamic analysis according to an example embodiment of the present disclosure;

FIG. 2 illustrates an example embodiment of an image that may be presented on a display including force vectors shown by arrows superimposed over the attachment points according to an example embodiment of the present disclosure;

FIG. 3 illustrates the system of FIG. 2 with the guide wire pushed further within the tube according to an example embodiment of the present disclosure;

FIG. 4 illustrates the system from a different perspective showing the base with the attachment points mounted thereto according to an example embodiment of the present disclosure;

FIG. 5 illustrates the base formed from a frame with the worksurface removed according to an example embodiment of the present disclosure;

FIG. 6 illustrates an example embodiment of an attachment point including a stem and an adjustable tie according to an example embodiment of the present disclosure;

FIG. 7 illustrates an example embodiment of a controller for a system that provides simulation of blood vessels and permits visualization of endovascular procedures along with the forces experienced by the blood vessels during such procedures according to an example embodiment of the present disclosure; and

FIG. 8 illustrates a flow chart of a method for that provides simulation of blood vessels and permits visualization of endovascular procedures along with the forces experienced by the blood vessels during such procedures according to an example embodiment of the present disclosure.

### DETAILED DESCRIPTION

Some embodiments of the present disclosure will now be described more fully hereinafter with reference to the accompanying drawings, in which some, but not all, embodiments of the disclosure are shown. Like reference numerals refer to like elements throughout. Indeed, various embodiments of the disclosure may be embodied in many different forms and should not be construed as limited to the embodiments set forth herein. Rather, these embodiments are provided so that this disclosure will satisfy applicable legal requirements.

As used herein, the term “or” is used in both the alternative and conjunctive sense, unless otherwise indicated. The term “along,” and similarly utilized terms, means near or on, but not necessarily requiring directly on an edge or other referenced location. The terms “approximately,” “generally,” and “substantially” refer to within manufacturing and/or engineering design tolerances for the corresponding materials and/or elements unless otherwise indicated. Thus, use of any such aforementioned terms, or similarly interchangeable terms, should not be taken to limit the spirit and scope of embodiments of the present disclosure.

The terms “about” or “approximately” as used herein when referring to a measurable value—such as, for example, length, width, height, separation and the like—are meant to encompass variations of ±20%, ±10%, ±5%, ±1%, ±0.5%, or even ±0.1% of the specified amount. A range provided herein for a measurable value may include any other range and/or individual value therein.

In general, various embodiments of the present disclosure provide improved designs for simulation of an arrangement of blood vessels within the body of a patient in the form of a vascular model. Embodiments provide visualization of a guide wire or other device as it is advanced within the simulated blood vessels, while sensors measure the force exerted by the guide wire as it is advanced through the simulated blood vessels and along a complex path. In some embodiments, a camera captures real-time images of the procedure while the measured forces are presented superimposed over the real-time images on a display. In doing so, a user may be provided with real-time feedback of the forces exerted on the simulated blood vessels as the guide wire is advanced within the vascular model. In this manner, users may be trained to navigate guide wires more safely and accurately through tortuous environments.

It will be understood and appreciated that such context is provided by way of example and uses of the blood vessel simulator to provide both visual feedback and force feedback to a user. The guide wire used herein is an example of a device that may be inserted into the blood vessel simulator. Such guide wires may be used to guide other medical objects through a blood vessel, such as catheters, needles, or stents.

In various embodiments, endovascular procedures are performed by navigating a guide wire through one or more blood vessels to position a medical object, such as catheters, needles, stents, and/or the like, within a target site at which treatment is desired. However, the narrow, tortuous structure of blood vessels may present challenges to accurately and safely navigating such devices to a target site. The vascular system is complex and involves various tortuous paths such that feeding a guide wire through a blood vessel is a complex and challenging process. Further, guide wires have limitations due in part to conflicting design parameters that require the guide wire to be flexible while also being sufficiently rigid to be properly guided through a blood vessel.

Guide wires are generally relatively flexible and provide significant torque transmission to allow the guide wire to be fed into a patient's blood vessels and to follow the path of such blood vessels while advancing to a target position. Guide wires are available in a variety of diameters and may be made of a variety of materials. When such guide wires are inserted into a patient's blood vessels, the guide wires may ideally be steered along the path of the blood vessel. However, with a limited degree of flexibility necessary to achieve a sufficiently rigid guide wire, following the curvilinear path of a blood vessel may be challenging. Improper insertion of a guide wire may damage blood vessels and have the potential to injure a patient.

Embodiments described herein provide an apparatus, system, and method for measuring and visualizing the forces exerted on blood vessels by a guide wire. It is important for a practitioner to understand the reaction forces from blood vessels responsive to insertion and steering of a guide wire through blood vessels. Excessive force from a guide wire on a blood vessel may damage the blood vessel and lead to potentially catastrophic consequences, such as a subarachnoid hemorrhage. Embodiments provide a system to separately show and visualize the reaction forces from the blood vessels for practitioners and for engineers who develop cardiovascular devices such that they may understand the dynamics of their procedures, differences in the devices used, and to improve a practitioner's techniques.

According to an example embodiment described herein, a medical practitioner may deliver endovascular devices through a vascular model while observing indications of the forces that they use as the guide wire pushes against the walls of blood vessels and as the guide wire pushes or penetrates an occlusion. Any forces exerted by endovascular devices on blood vessels may be measured and visually presented to a user. Because these forces deliver the devices to the target blood vessels, retrieve clots, or penetrate a chronic total occlusion (CTO), data associated with these forces is desirable to be known for the efficacy of the endovascular devices. As these forces may cause rupture of blood vessel walls, the force information may be critical for the safety of the devices and interventional operations.

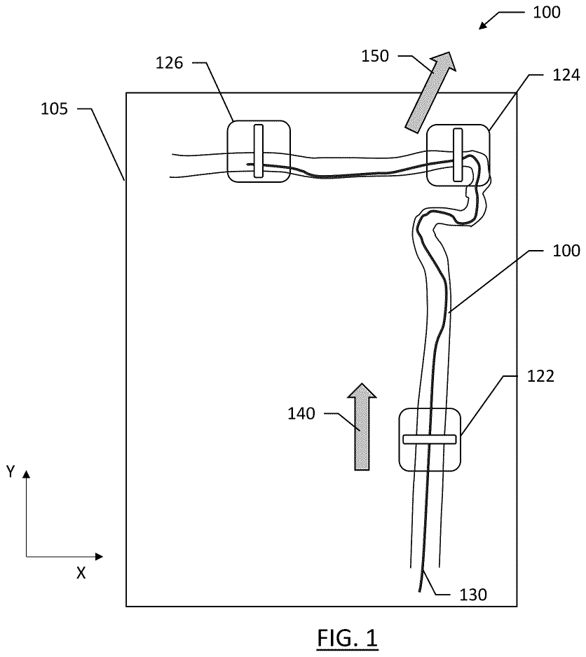

FIG. 1 illustrates an example of a system 100 for visualization of the forces for objective dynamic analysis. As shown, a tube 110 is held in place using attachment points 120 of the system 100. The tube may be made, for example, of a silicone or other material. According to some embodiments, the tube may be specifically configured to have a wall thickness and strength that may simulate the walls of a blood vessel. However, as the force feedback is not dependent upon this, such tubing is not necessary to understand the forces acting on the simulated blood vessel. A guide wire 130 may be inserted into the tube 110 and navigated along the tube and through the bends of the tube. A series of attachment points 122, 124, and 126 may be mounted on a base 105 of the system 100, with force sensors positioned between the attachment points and the base.

The force sensors are configured to detect forces exerted on the attachment points. The force sensors may include load cells, such as a highly sensitive load cell having precision of within 0.01 grams to measure forces at the attachment point as a user maneuvers a guide wire 130 through the tube 110. Force sensors may optionally include pressure sensors, strain gauges, piezo sensors, optical force sensors, inductive force sensors, magnetic force sensors, and/or the like. The force sensors may measure forces exerted in two dimensions, such as along the X-axis and Y-axis shown in FIG. 1. Optionally, the force sensors may be configured to detect forces exerted in a third dimension, such as scenarios in which the blood vessel simulator includes a vascular model that has dimensionality in the Z-axis. As shown, a first force depicted by arrow 140 may be exerted within the tube 110, such as based upon friction of the guide wire 130 engaging a side of the tube and measured at attachment point 122. A second force depicted by arrow 1650 may be exerted within the tube 110 at attachment point 124, such as when the guide wire makes the turn around the bend at the attachment point.

For real-time visualization, the forces measured at each attachment point may be presented on a display in the form of numerical forces or, in some embodiments, as arrows superimposed over a video feed of the system 100 at the respective position of the sensor measuring the force. Such an interactive display may provide real time force feedback with dynamic interplay between the blood vessel walls and the guide wire during the procedure. This enables a user to obtain a touch or feel for the guide wire and to understand what frictional forces are acceptable and when forces become too substantial.

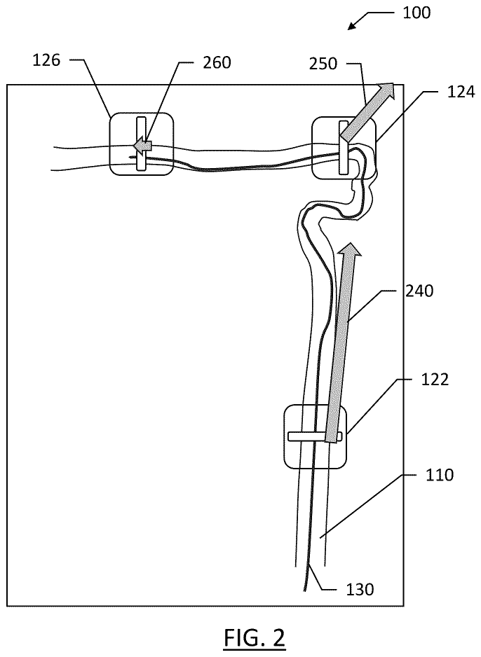

FIG. 2 illustrates an example embodiment of an image that may be presented on a display including force vectors shown by arrows superimposed over the attachment points. As shown, the force vector shown by arrow 240 indicates the frictional force between the guide wire 130 and the cervical part of the system 100 corresponding to the internal carotid artery (ICA) as well as some of the reaction force from the petrous and cavernous part as measured at attachment point 122. The force vector shown by arrow 250 on the right/upper portion of the system 100 shows the force from the cavernous to the entrance of the middle cerebral artery (MCA) as measured at the attachment point 124. Both force vectors show that, as the user pushes the guide wire 130, the blood vessel represented by the tube 110 applies a reverse pressure to the wire. When one releases the force without pushing the wire deep enough, the wire will be “kicked back.”

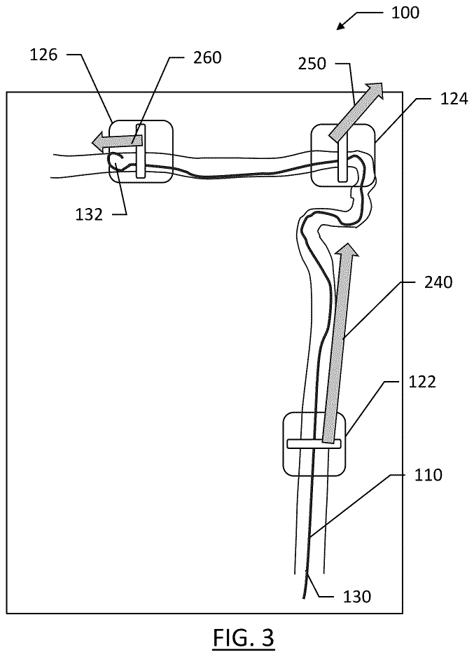

As a user pushes the guide wire 130 further, the force increases. The force sensor of the left/upper corner attachment point 126 may sense the frictional force between the tip of the guide wire 130 and the blood vessel wall as shown by arrow 260 measured at attachment point 126. FIG. 3 illustrates the system of FIG. 2 with the guide wire 130 pushed further within the tube 110. As shown, the end of the guide wire 130 is buckled and coiled up at 132 such that the tip directly pushes on the tube 110 and there is a readily noticeable force at the attachment point 126 reflected by larger arrow 260.

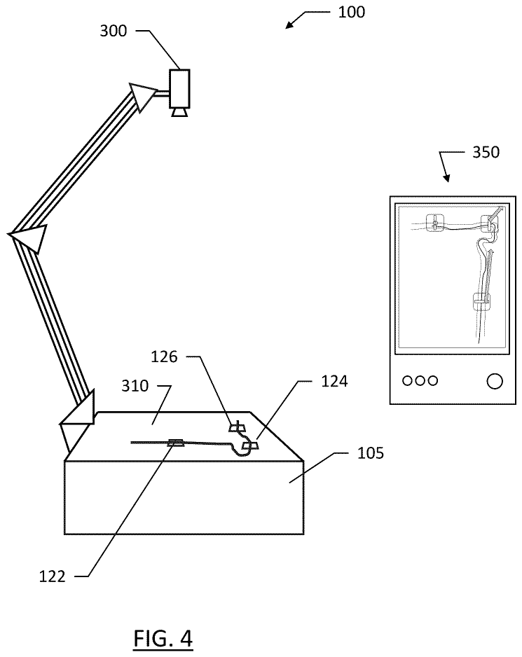

FIG. 4 illustrates the system 100 from a different perspective showing the base 105 with the attachment points 122, 124, and 126 mounted thereto. Also shown is a camera 300 positioned on an arm 305 extending above the base 105. This camera 300 is used to capture real time images of the tube and attachment points as a user is inserting a guide wire into the tube, such that the real time image captured may be presented on a display 350 with the arrows indicating the forces seen at the attachment points superimposed over the real time image. Also shown in FIG. 4 is the worksurface 310. This work surface is typically a light color such as white to allow the tube and attachment points to be visible within the field of view of the camera and permits the guide wire to be seen traveling within the tube due to the contrast.

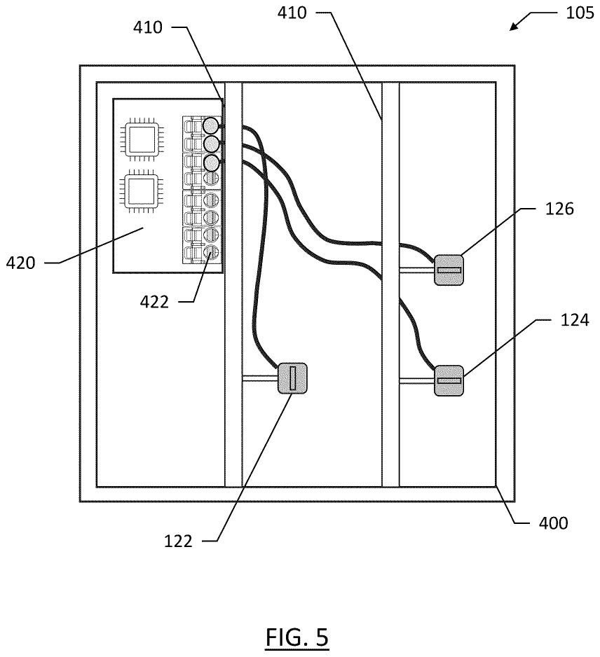

FIG. 5 illustrates the base 105 with the worksurface removed. The base 105 is formed from a frame 400, which may be a structurally sound frame made of a material such as aluminum. Within the frame 400 are adjustable cross members 410. These adjustable cross members may be repositioned within the frame, and the attachment points 122, 124, and 126 repositionable along a length of the cross members 410. This enables the attachment points to be adjustable to be in any position within the frame to replicate any blood vessel shape and size.

Within the frame is also a controller 420 which may include a circuit board to which the load sensors are connected. The controller 420, described further below, may also include the ability to receive the video feed captured via the camera 300 and to superimpose the arrows representing forces as measured at each attachment point by a respective load sensor. The controller 420 may then output a video feed to a display on which a user may view real time images of the system 100 and the real time forces measured at each of the force sensors of the attachment points. The controller 420 may be configured with a plurality of ports 422, with each port permitting the connection of a force sensor. More or fewer attachment points and corresponding force sensors may be used depending upon the specific vascular model to be simulated.

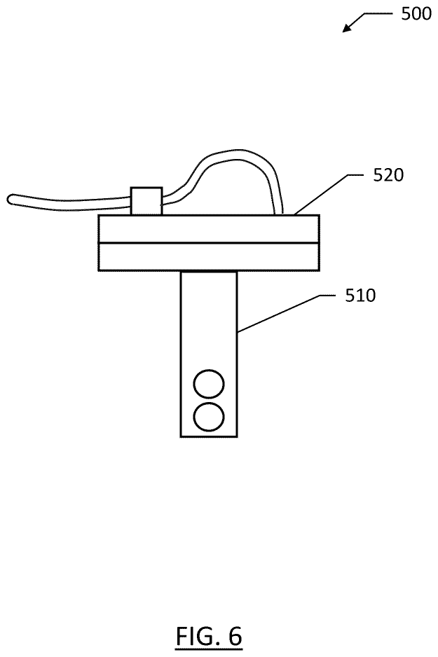

FIG. 6 illustrates an example embodiment of an attachment point 500 including a stem 510 and an adjustable tie 520. When installed in the base, the stem 510 is attached to the base (e.g., at a cross member) by way of a force sensor. The adjustable tie 520 secures the tube to the attachment point and the adjustable nature enables tubing of various diameters to be used.

The attachment point 500 may be rotated when attached to the base such that the adjustable tie 520 holds the tube in the correct orientation. Optionally, the adjustable 520 tie may be freely rotatable on the stem 510, such as using a magnet, a rotatable fastener (e.g., a rivet), or other mechanism. Further, while the illustrated adjustable tie 520 is dark in color, the adjustable tie may optionally be transparent for better visibility of the inside of the tube.

The attachment points in the image of the worksurface and the attachment points may be identified through object recognition whereby the adjustable tie 520 is identified as an attachment point. A user may configure which sensor the recognized attachment point is associated with. Optionally, a user may identify an attachment point within the image and associate a corresponding sensor. This enables the controller 420 to properly position the arrows that are superimposed over the image when presented on a display.

According to some embodiments, the controller 420 is in communication, such as by a communications interface, with a user interface, such as a display. The display may be used to present the image of the worksurface, the attachment points, the guide wire, and the superimposed force vectors. This may provide an indication of a magnitude of forces experienced at each of the attachment points responsive to the insertion and movement of the guide wire within the tubing. The magnitude of the forces experienced at each of the attachment points may be conveyed by virtue of the size (length and/or width) of the force vector arrows. Optionally, threshold force values may be used to identify when a force is below a magnitude that is likely to cause any vascular damage. This may be conveyed by a color of a force vector arrow such as green. Optionally, another threshold may be used to identify when a force is approaching a magnitude that is likely to cause any vascular damage. This may be conveyed by a color of the force vector arrow (e.g., yellow) and/or by way of an alert presented on the display. If a force experienced at an attachment point is above a threshold at which vascular damage is likely, this may be conveyed to a user by a color of the force vector arrow, such as red, and/or by an alert presented on the display.

The thresholds described above may be associated with a type of vessel that is being represented by the tubing, where different vessels may have different strengths and ability to withstand differing forces. Thresholds may also be associated with characteristics of a patient. For example, young children or elderly patients may have weaker blood vessels such that thresholds may be lower for forces that may cause damage to such blood vessels.

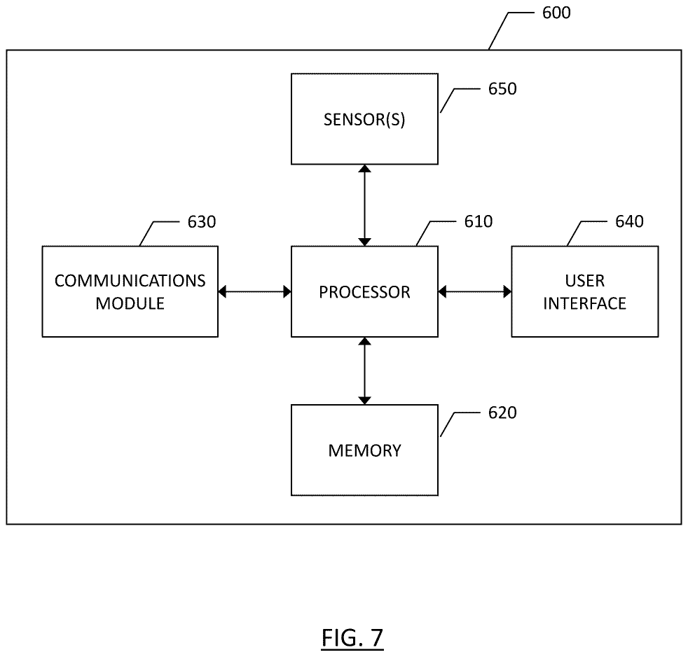

FIG. 7 illustrates an example embodiment of a controller 420 for a system that provides simulation of blood vessels and permits visualization of endovascular procedures along with the forces experienced by the blood vessels during such procedures as provided herein. The controller 420 as represented through the apparatus 600 of the schematic diagram of FIG. 7 of an example of an apparatus 600 configured to perform procedures as described herein. The apparatus 600 may include or otherwise be in communication with a processor 610, a memory 620, a communication module 630, a user interface 640, and sensor(s) 650 which may include a force sensor as described above. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 610 (and/or co-processors or any other processing circuitry assisting or otherwise associated with the processor) may be in communication with the memory 620 via a bus for passing information among components of the apparatus. The memory 620 may include, for example, one or more volatile and/or non-volatile memories. In other words, for example, the memory 620 may be an electronic storage device (e.g., a computer readable storage medium) comprising gates configured to store data (e.g., bits) that may be retrievable by a machine (e.g., a computing device like the processor). The memory 620 may be configured to store information, data, content, applications, instructions, or the like for enabling the apparatus 600 to carry out various functions in accordance with an example embodiment of the present disclosure. For example, the memory 620 could be configured to buffer input data for processing by the processor 610. Additionally, or alternatively, the memory could be configured to store instructions for execution by the processor.

The processor 610 may be embodied in a number of different ways. For example, the processor 610 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally, or alternatively, the processor 610 may include one or more processors configured in tandem via the bus to enable independent execution of instructions, pipelining and/or multithreading.

In an example embodiment, the processor 610 may be configured to execute instructions stored in the memory 620 or otherwise accessible to the processor 610. Alternatively, or additionally, the processor 610 may be configured to execute hard coded functionality. As such, whether configured by hardware or software methods, or by a combination thereof, the processor 610 may represent an entity (e.g., physically embodied in circuitry) capable of performing operations according to an embodiment of the present invention while configured accordingly. Thus, for example, when the processor 610 is embodied as an ASIC, FPGA or the like, the processor 610 may be specifically configured hardware for conducting the operations described herein. Alternatively, as another example, when the processor 610 is embodied as an executor of software instructions, the instructions may specifically configure the processor 610 to perform the algorithms and/or operations described herein when the instructions are executed. However, in some cases, the processor 610 may be a processor of a specific device configured to employ an embodiment of the present invention by further configuration of the processor 610 by instructions for performing the algorithms and/or operations described herein. The processor 610 may include, among other things, a clock, an arithmetic logic unit (ALU) and logic gates configured to support operation of the processor 610. In one embodiment, the processor 610 may also include user interface circuitry configured to control at least some functions of one or more elements of the user interface 640.

The communication module 630 may include various components, such as a device or circuitry embodied in either hardware or a combination of hardware and software that is configured to receive and/or transmit data for communicating data between the apparatus 600 and various other entities, such as a remote display system, for example. In this regard, the communication module 630 may include, for example, an antenna (or multiple antennas) and supporting hardware and/or software for enabling communications wirelessly. Additionally, or alternatively, the communication module 630 may include the circuitry for interacting with the antenna(s) to cause transmission of signals via the antenna(s) or to handle receipt of signals received via the antenna(s). For example, the communications module 630 may be configured to communicate wirelessly such as via Wi-Fi (e.g., vehicular Wi-Fi standard 802.11p), Bluetooth, mobile communications standards (e.g., 3G, 4G, or 5G) or other wireless communications techniques. In some instances, the communications module 630 may alternatively or also support wired communication, which may communicate with a separate transmitting device (not shown). As such, for example, the communications module 630 may include a communication modem and/or other hardware/software for supporting communication via cable, digital subscriber line (DSL), universal serial bus (USB) or other mechanisms. For example, the communications module 630 may be configured to communicate via wired communication with other components of a computing device.

The apparatus 600 may include sensors 650 that may correspond the load sensors used at the attachment points. Sensors 650 may also include an image sensor in the form of a camera capturing images of the system. Signals from the sensors 650 may be processed by the processor 610 to reflect the force measured at the respective sensor. An acceptable force range may be stored, for example, in memory 620. The user interface 640, which may include a display, may provide for display of images from the image sensor and overlay visual indications of the forces measured by the force sensors. The vascular simulation system described herein may be implemented with a software program, such as an application (e.g., a device app) that interfaces with the system and a display.

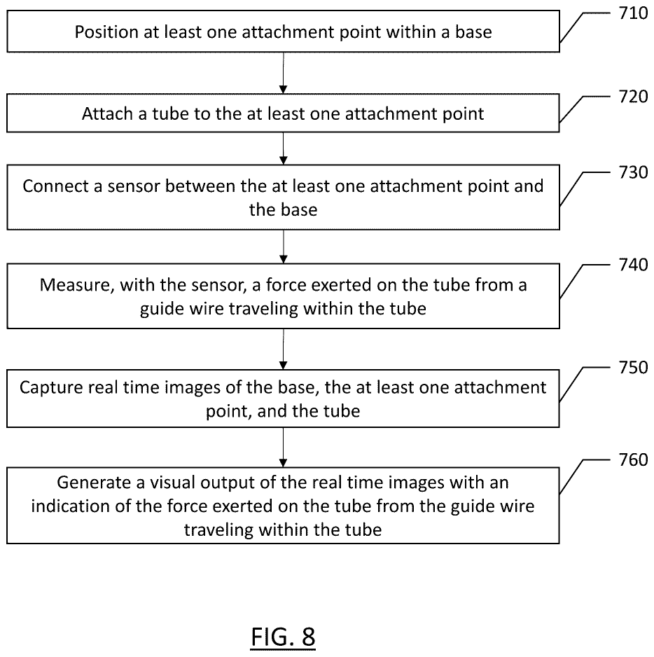

Having described example vascular model systems in accordance with the disclosure, example processes of the disclosure will now be discussed. It will be appreciated that the flowcharts depict example processes for fabricating and using a vascular model system described herein. FIG. 8 illustrates a flowchart of a method according to an example embodiment of the disclosure. It will be understood that numerous blocks of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory 620 of an apparatus employing an embodiment of the present invention and executed by the processor 610 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

The depicted blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. It should be appreciated that one or more of the operations of each flowchart may be combinable, replaceable, and/or otherwise altered as described herein.

As shown in FIG. 8, at least one attachment point is positioned within a base as shown at 710. A tube is attached to the at least one attachment point at 720. A sensor is connected between the at least one attachment point and the base as shown at 730. At 740, a force exerted on the tube from a guide wire traveling within the tube is measured by the sensor. Real time images of the base, the at least one attachment point, and the tube are captured at 750. A visual output of the real time images is generated with an indication of the force exerted on the tube from the guide wire traveling within the tube as shown at 760.

In an example embodiment, an apparatus for performing the method of FIG. 8 above may, at least in part, comprise a processor (e.g., the processor 610) configured to perform some or each of the operations (710-760) described above. The processor may, for example, be configured to perform the operations (710-760) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 710-760 may comprise, for example, the processor 610 and/or a device or circuit for executing instructions or executing an algorithm for processing information as described above.

In some embodiments, certain ones of the operations above may be modified or further amplified. Furthermore, in some embodiments, additional optional operations may be included. Modifications, additions, or amplifications to the operations above may be performed in any order and in any combination.

While some embodiments described herein relate to the insertion of guide wires within a vascular model, one of ordinary skill in the art will appreciate that the teachings herein may also apply to a wide range of medical procedures and apparatuses that can be inserted and manipulated within tortuous environments. The embodiments described herein may also be scalable to accommodate at least the aforementioned applications. Various components of embodiments described herein can be added, removed, reorganized, modified, duplicated, or the like as one skilled in the art would find convenient and/or necessary to implement a particular application in conjunction with the teachings of the present disclosure. In some embodiments, specialized features, characteristics, materials, components, and/or equipment may be applied in conjunction with the teachings of the present disclosure as one skilled in the art would find convenient and/or necessary to implement a particular application.

Moreover, many modifications and other embodiments of the present disclosure set forth herein will come to mind to one skilled in the art to which this disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of any appended claims. Moreover, although the foregoing descriptions and the associated drawings describe example embodiments in the context of certain example combinations of elements and/or functions, it should be appreciated that different combinations of elements and/or functions can be provided by alternative embodiments without departing from the scope of any appended claims. In this regard, for example, different combinations of elements and/or functions than those explicitly described above are also contemplated as can be set forth in some of any appended claims. Although specific terms are employed herein, they are used in a generic and descriptive sense only and not for purposes of limitation.

That which is claimed is:

1. A vascular model system comprising:
a base;
at least one attachment point;
a tube attached to the at least one attachment point;
at least one sensor, wherein the at least one attachment point is attached to the at least one sensor, and wherein the at least one sensor is mounted to the base, wherein the at least one sensor is configured to detect a force exerted on the tube from a guide wire traveling within the tube at the at least one attachment point;
a camera, wherein the camera is positioned to capture images of the base, the at least one attachment point, and the tube; and
a controller, wherein the controller is configured to generate a visual output of the images with an indication of the force exerted on the tube from the guide wire traveling within the tube at the at least one attachment point.

2. The vascular model system of claim 1, wherein the indication comprises a force vector superimposed over an attachment point of the at least one attachment point, wherein the force vector provides the indication of the force exerted on the tube from the guide wire traveling within the tube at the at least one attachment point.

3. The vascular model system of claim 2, wherein the force vector provides the indication of a direction of the force exerted on the tube from the guide wire traveling within the tube at the at least one attachment point.

4. The vascular model system of claim 3, wherein the force vector defines a size, wherein the size of the force vector reflects a magnitude of the force exerted on the tube from the guide wire traveling within the tube at the at least one attachment point.

5. The vascular model system of claim 3, wherein the force vector defines a color, wherein the color of the force vector reflects a magnitude of the force exerted on the tube from the guide wire traveling within the tube at the at least one attachment point.

6. The vascular model system of claim 5, wherein the color of the force vector is a first color in response to the magnitude of the force exerted on the tube from the guide wire traveling within the tube at the at least one attachment point being below a threshold, and wherein the color of the force vector is a second color in response to the magnitude of the force exerted on the tube from the guide wire traveling within the tube at the at least one attachment point being above the threshold.

7. The vascular model system of claim 1, wherein the at least one attachment point is rotatable relative to the at least one sensor.

8. The vascular model system of claim 7, wherein the at least one attachment point is connected to the at least one sensor by a magnet.

9. The vascular model system of claim 1, wherein the at least one attachment point is repositionable within the base.

10. The vascular model system of claim 9, wherein the at least one attachment point and the tube attached to the at least one attachment point are positioned to simulate a blood vessel shape and size within a human vascular system.

11. The vascular model system of claim 1, wherein the at least one sensor comprises a pair of load cells, wherein the pair of load cells are configured to measure the force exerted on the tube from the guide wire traveling within the tube at the at least one attachment point in two orthogonal axes.

12. A method for visualizing forces of a guide wire within a vascular model, the method comprising:
positioning at least one attachment point on a base;
attaching a tube to the at least one attachment point;
connecting a sensor between the at least one attachment point and the base;
measuring, with the sensor, a force exerted on the tube from a guide wire traveling within the tube at the at least one attachment point;
capturing images of the base, the at least one attachment point, and the tube; and
generating a visual output of the images with an indication of the force exerted on the tube from the guide wire traveling within the tube at the at least one attachment point.

13. The method of claim 12, further comprising:
providing the indication of the force exerted on the tube from the guide wire traveling within the tube at the at least one attachment point as a force vector.

14. The method of claim 13, wherein the force vector provides the indication of a direction of the force exerted on the tube from the guide wire traveling within the tube at the at least one attachment point.

15. The method of claim 14, wherein the force vector defines a size, wherein the size of the force vector reflects a magnitude of the force exerted on the tube from the guide wire traveling within the tube at the at least one attachment point.

16. The method of claim 14, wherein the force vector defines a color, wherein the color of the force vector reflects a magnitude of the force exerted on the tube from the guide wire traveling within the tube at the at least one attachment point.

17. The method of claim 16, wherein the color of the force vector is a first color in response to the magnitude of the force exerted on the tube from the guide wire traveling within the tube at the at least one attachment point being below a threshold, and wherein the color of the force vector is a second color in response to the magnitude of the force exerted on the tube from the guide wire traveling within the tube at the at least one attachment point being above the threshold.

18. The method of claim 12, wherein the at least one attachment point is rotatable relative to the sensor.

19. The method of claim 18, wherein the at least one attachment point is connected to the sensor by a magnet.

20. The method of claim 12, further comprising: repositioning the at least one attachment point within the base.

21. The method of claim 20, wherein the at least one attachment point and the tube attached to the at least one attachment point are positioned on the base to simulate a blood vessel shape and size within a human vascular system.

22. The method of claim 12, wherein the sensor comprises a pair of load cells, wherein the pair of load cells are configured to measure the force exerted on the tube from the guide wire traveling within the tube at the at least one attachment point in two orthogonal axes.

23. A computer program product comprising at least one non-transitory computer-readable storage medium having computer-executable program code portions stored therein, the computer-executable program code portions comprising program code instructions configured to:
measure, with at least one sensor, a force exerted on a tube from a guide wire traveling within the tube at one or more attachment points to a base;
capture images of the base, the one or more attachment points, and the tube; and
generate a visual output of the images with an indication of the force exerted on the tube from the guide wire traveling within the tube at the one or more attachment points.

24. The computer program product of claim 23, further comprising program code instructions to:
provide the indication of the force exerted on the tube from the guide wire traveling within the tube at the one or more attachment points as a force vector.

25. The computer program product of claim 24, wherein the force vector provides the indication of a direction of the force exerted on the tube from the guide wire traveling within the tube at the one or more attachment points.

26. The computer program product of claim 25, wherein the force vector defines a size, wherein the size of the force vector reflects a magnitude of the force exerted on the tube from the guide wire traveling within the tube at the one or more attachment points.

27. The computer program product of claim 25, wherein the force vector defines a color, wherein the color of the force vector reflects a magnitude of the force exerted on the tube from the guide wire traveling within the tube at the one or more attachment points.

28. The computer program product of claim 27, wherein the color of the force vector is a first color in response to the magnitude of the force exerted on the tube from the guide wire traveling within the tube at the one or more attachment points being below a threshold, and wherein the color of the force vector is a second color in response to the magnitude of the force exerted on the tube from the guide wire traveling within the tube at the one or more attachment points being above the threshold.
